(19) United States
(12) Patent Application Publication
(10) Pub. No.: US 2014/0379310 A1
(43) Pub. Date: Dec. 25, 2014

(54) Methods and Systems for Evaluating Predictive Models

(71) Applicant: Citigroup Technology, Inc., Weehawken, NJ (US)

(72) Inventors: Raji Ramachandran, Tampa, FL (US); Scott Lustig, Mineola, NY (US); H. Ian Joyce, Charlton, MA (US); Rajesh Jugulum, Franklin, MA (US); Eliud Polanco, New York, NY (US); Satya Vithala, Cranbury, NJ (US); Ron Guggenheimer, Great Neck, NY (US); Sami Huovilainen, New York, NY (US); Jagmeet Singh, Quincy, MA (US); Robert Granese, Wenham, MA (US)

(21) Appl. No.: 13/927,068

(22) Filed: Jun. 25, 2013

(51) Int. Cl. G06N 7/00

(52) U.S. Cl. CPC G06N 7/00
USPC 703/2

(57) ABSTRACT

Multidimensional methods and systems for evaluating and comparing predictive models involve, for example, receiving data related to predictions produced by each of a plurality of different predictive models and determining a score for each of a plurality of dimensions for each of the predictive models. A composite score may be calculated for each of the predictive models based at least partly on the dimension scores, and a recommendation may be generated based on comparing the composite scores.

### FIELD OF THE INVENTION

The present invention relates generally to the field of predictive modeling, and more particularly to multidimensional methods and systems for evaluating and comparing predictive models.

### BACKGROUND OF THE INVENTION

The commoditization of predictive modeling has accelerated the use of contextual predictive analytics and the offering of such services for addressing horizontal business problems, such as employee or customer churn analysis, financial forecasting based on macroeconomic trends, and defect pattern recognition for root cause analysis. Financial services organizations may consider the purchase of such services in order to obtain a cost-effective competitive advantage.

Regulatory bodies have placed heavy emphasis on developing governance systems around predictive models used by financial organizations to run their businesses. However, there is currently no sound quantitative methodology for evaluating the strengths and weaknesses of predictive models available on the market.

Currently available methods focus on one aspect at a time and do not combine all available information to give a more complete, holistic view. Also, available methods employ bottom up approaches. Further, distribution free statistical methods, such as Euclidean distance techniques, are not helpful. A framework and rigorous mathematical approach to satisfy the need for an improved method of evaluating predictive models does not currently exist.

In the credit card industry, for example, card issuers may currently use different kinds of predictive models to enable a card issuer to attempt to determine, for example, which of its credit card holders may be likely to cancel their card accounts and which may be likely to maintain their accounts based on variables related to the cardholders' activity. Vendors may perform those kinds of analyses based on data provided by the card issuers about their customers.

Such vendors may generate a prediction which may be correct to a certain extent but also wrong to a certain extent. It is common to measure the accuracy of a predictive model using currently available methodologies. However, such currently available methodologies generally limit such evaluation of predictive models to that single accuracy dimension. There is a present need for a sound quantitative methodology for evaluating the strengths and weaknesses of predictive models that is not currently met by offerings in the market.

### SUMMARY OF THE INVENTION

Embodiments of the invention may employ computer hardware and software, including, without limitation, one or more processors coupled to memory and non-transitory, computer-readable storage media with one or more executable computer application programs stored thereon which instruct the processors to perform multidimensional methods and systems for evaluating and comparing predictive models described herein.

Such embodiments may involve, for example, receiving, using a processor coupled to memory, data related to predictions produced by each of a plurality of different predictive models. Using the processor, a score may be determined for each of a plurality of pre-selected dimensions for each of the plurality of different predictive models. Likewise using the processor, a composite score may be calculated for each of the plurality of different predictive models based at least in part on the dimension scores. Also using the processor, the calculated composite scores may be compared and a recommendation may be generated based on the comparison.

In aspects of embodiments of the invention, receiving the data may involve, for example, receiving data related to predictions of behavior patterns of consumers produced by each of the plurality of different predictive models. In other aspects, receiving the data related to predictions of behavior patterns of consumers may involve, for example receiving data related to predictions of disengaging behavior patterns of consumers produced by each of the plurality of different predictive models.

In further aspects of embodiments of the invention, determining the score for each of the plurality of pre-selected dimensions may involve, for example, defining parameters of each of the plurality of pre-selected dimensions for each of the plurality of different predictive models. In still further aspects, determining the score for each of the plurality of pre-selected dimensions may involve, for example, determining a score for an accuracy dimension and a score for at least one other of the plurality of pre-selected dimensions for each of the plurality of different predictive models.

In additional aspects of embodiments of the invention, determining the score for the accuracy dimension may involve, for example, quantifying a predictive accuracy and reliability of the predictions produced by each of the plurality of different predictive models. In further aspects, determining the score for at least one other of the pre-selected dimensions may involve, for example, determining the score for at least one of a value dimension, a utility dimension, and an actionability dimension for each of the plurality of different predictive models. In other aspects determining the score for at least one other of the pre-selected dimensions, may involve, for example, determining the score for each of a value dimension, a utility dimension, and an actionability dimension for each of the plurality of different predictive models

In other aspects of embodiments of the invention, determining the score for the value dimension may involve, for example, quantifying a cost savings associated with acting on predictions produced by each of the plurality of different predictive models. In additional aspects, determining the score for the utility dimension may involve, for example, quantifying a usability of predictions produced by each of the plurality of different predictive models. In further aspects, determining the score for the actionablity dimension may involve, for example, quantifying an ability to take action on predictions produced by each of the plurality of different predictive models. In still other aspects, determining the score for each of the plurality of pre-selected dimensions may involve, for example, determining a numerical percentage score for each of the plurality of pre-selected dimensions for each of the predictive models.

In still further aspects of embodiments of the invention, calculating the composite score may involve, for example, deriving a Z-score for each of the plurality of pre-selected dimensions for each of the different predictive models. In additional aspects, calculating the composite score may involve, for example, summing the Z-scores derived for the plurality of pre-selected dimensions for each of the different predictive models. In other aspects, comparing the calculated composite scores may involve, for example, identifying one of the plurality of different predictive models as suitable for a particular project. In still other aspects, generating the recommendation may involve, for example, recommending one of the plurality of different predictive models as suitable for a particular project.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a table that illustrates an example of composite score calculation for a predictive model in the multidimensional process of evaluating and comparing predictive models for embodiments of the invention;

FIG. 2 is a flow chart which illustrates an example of the multidimensional process of evaluating and comparing predictive models for embodiments of the invention; and

FIG. 3 is a flow chart which illustrates another example of the multidimensional process of evaluating and comparing predictive models for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention may utilize one or more special purpose computer software application program processes, each of which is tangibly embodied in a physical storage device executable on one or more physical computer hardware machines, and each of which is executing on one or more of the physical computer hardware machines (each, a “computer program software application process”). Physical computer hardware machines employed in embodiments of the invention may comprise, for example, input/output devices, motherboards, processors, logic circuits, memory, data storage, hard drives, network connections, monitors, and power supplies. Such physical computer hardware machines may include, for example, user machines and server machines that may be coupled to one another via a network, such as a local area network, a wide area network, or a global network through telecommunications channels which may include wired or wireless devices and systems.

As noted, in the present business environment, predictive modeling has become commoditized, and the available ensemble of models and regulatory pressures has created a need for a cost-effective, methodology-agnostic way of evaluating, comparing, and monitoring the performance of predictive models. Defining an analytics performance-measuring and monitoring framework for embodiments of the invention that is methodology agnostic may involve, for example, formulating an evaluation framework, performing quantitative analysis as prescribed in the evaluation framework, communicating results, and standardization.

Embodiments of the invention propose to measure not only the accuracy of predictive models but other factors, as well. Accordingly, embodiments of the invention may employ multiple criteria in measuring the effectiveness of a predictive model. For example, embodiments of the invention propose to measure other dimensions, such as the value of a predictive model, in addition to the accuracy of the predictive model.

Embodiments of the invention may also quantify cost savings, actionability (i.e., an ability to take action on the predictions), and usability of the predictions. Thus, embodiments of the invention evaluate predictive models based on more than one criterion or along more than one dimension.

The multidimensional aspect of embodiments of the invention may involve evaluating predictive models in terms, for example, of accuracy, value or cost savings, utility or usability, and actionability. Embodiments of the invention may be employed successfully, for example, in evaluating predictive models used with extremely large and complex data sets commonly referred to as “big data”.

An objective of the performance measurement and monitoring framework for embodiments of the invention may involve, for example, measuring and monitoring the predictive power of various analytics projects by grouping them into the four dimensions of accuracy, value, utility, and actionability. Embodiments of the invention provide a novel, multidimensional system for evaluating and comparing predictive models in which such models are scored, for example, against those four dimensions. The score for each of the dimensions may be expressed as a numerical value, such as a percentage.

In embodiments of the invention, the accuracy dimension may quantify and monitor a predictive accuracy and reliability of a predictive model. Determination of the accuracy dimension of a predictive model may involve use of analytic tools, such as statistical process control (SPC) charts, Pareto charts, signal-to-noise ratio (SNR) analysis, measurement system analysis (MSA), and/or any other suitable analytic tools.

The value dimension may be interpreted in conjunction, for example, with the accuracy measure and may quantify the business value of a prediction profiled across samples and over time. In a particular context, the value dimension determination may consider, for example, aggregated lost sales in terms of probability of disengagement for each customer. Tools employed to determine the value dimension may include analytic tools, such as cost benefit analysis (CBA) and time series analysis. Likewise, any other suitable analytic tools may be used in the determination of the value dimension.

The utility dimension may quantify, for example, whether or not a particular model is an improvement over existing models or other industry benchmarks. In other words, the utility dimension may address, for example, whether or not existing predictive models already provide the same predictions as the particular model and the level of improvement over such existing models that is achieved by the particular model. The utility dimension may also address, for example, whether there are any industry benchmarks and, if so, the level of improvement that is achieved by the particular model over such benchmarks. Determining the utility dimension may involve use of analytics tools, such as logit and probit model comparisons and measurement of percent lift.

The actionability dimension determination may be interpreted, for example, as percentage response rate. The actionability dimension may address, for example, whether or not predictions of a particular predictive model provide input for treatments that comply with policies and are socially responsible. The determination of the actionability dimension may involve, for example, testing and measuring outcomes or response rate percentages that are policy compliant and socially responsible.

Assume, for example, that a predictive model is run to predict the likelihood of customers' disengagement of a credit card. In other words, such predictive model may be used in attempting to predict when customers may stop using a particular credit card or when customers may begin to use the particular credit card less frequently. The dimensions of accuracy, value, utility and actionability may be defined and determined for the predictive model.

In the example, accuracy may be defined as how well each predictive model is able to predict whether a particular customer is engaging or disengaging. Value may be defined, for example, as an amount of revenue that is lost if a customer disengages.

Regarding the value dimension, the predictive model may prove quite accurate, for example, in predicting that a customer will disengage, but if there is little or no revenue from the disengaging customer, the value dimension may be negligible.

Utility may be defined as how well the predictive model performs in the foregoing example. With regard to actionability, assume, for example, that the predictive model makes certain predictions about possible actions that may be taken, such as providing incentives, for a customer to use his or her credit card. Therefore, actionablity may be defined as likelihood that the customer will use the credit card if those incentives are provided. In such context, actionability may also be referred to as a response rate.

In certain cases, the predictive model may produce a prediction that is not actionable. For example, it may be known that certain population segments are more likely than others to behave in a particular fashion. However, it may not be socially responsible to act on a particular prediction with respect to such population segments. Thus, even though the predictive model may predict a certain behavior, it may not be acted upon because there is no business value for that particular prediction which may, for example, offend political sensibilities.

A prediction is a starting point of the framework for embodiments of the invention. Thus, the quantities or dimensions of accuracy, value, utility, and actionability may be measured for a set of predictions produced by each of multiple predictive models. Such dimensions may be viewed as separate quantitative measures or may be aggregated into a single score for each predictive model. In the foregoing example in which an objective may be to identify behavior patterns of consumers, such as disengaging customers, any number of different predictive models that are known to those skilled in the art may be run.

After each predictive model is run, the framework for embodiments of the invention may be updated. For example, for a predictive model, such as a neural network predictive model, scores for the dimensions of accuracy, value, utility or usability, and actionability may be calculated. Based on the scores for those dimension, a composite score may then be calculated for the neural network predictive analysis.

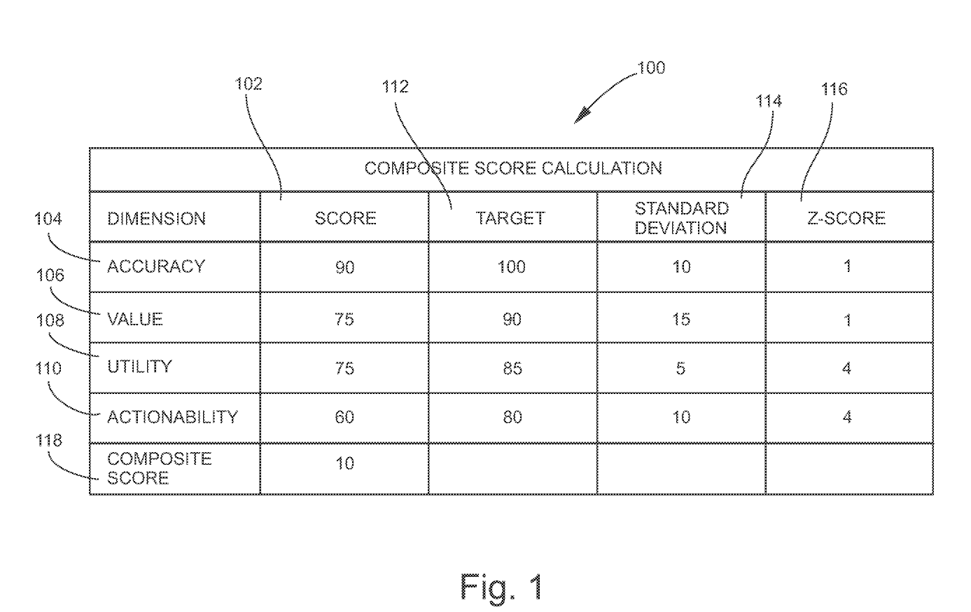

FIG. 1 is a table 100 that illustrates an example of a composite score calculation for a predictive model in the multidimensional process of evaluating and comparing predictive models for embodiments of the invention. Referring to FIG. 1, a score 102 for a particular predictive model may be determined for each of the dimensions of accuracy 104, value 106, utility 108, and actionability 110. A target 112 and a standard deviation 114 may likewise be determined for each of the dimensions. In the example shown, a standard or Z-score 116 may be derived for each dimension as the square of the quotient of the difference between the target 112 and score 102 divided by the standard deviation 114. The composite score 118 for the particular predictive model may be the sum of the Z-scores 116.

Thereafter, scores for the dimensions of accuracy, value, utility or usability, and actionability may be similarly calculated for a second predictive model, such as a disconnect analysis predictive model. Likewise based on the scores for those dimension, a composite scores may be calculated for the disconnect predictive analysis. Further scores for the dimensions of accuracy, value, utility or usability, and actionability may also be calculated for any number of additional predictive models that may be used for the particular project, as well as composite scores for each of such predictive models.

The scores of the different predictive models may then be compared to identify a particular predictive model with the best score, taking into consideration all of the dimensions of accuracy, value, utility, and actionability. Thus, in the foregoing example of the disengaging customer project, a recommendation may then be generated to use the predictive model with the best score.

Using the framework for embodiments of the invention, any number of predictive models may be run and scored and their respective scores compared to determine which one of the predictive models is the best for providing the greatest value in a particular situation. The process may begin with a particular problem or project and a selection of any number of suitable predictive modeling techniques for the given project.

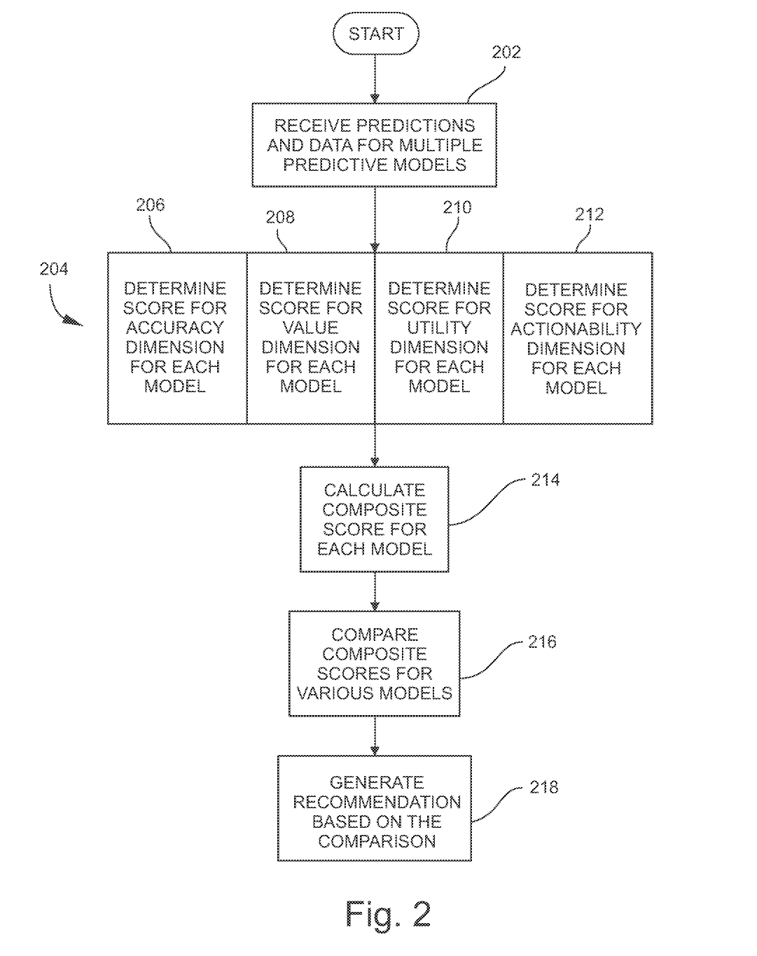

FIG. 2 is a flow chart which illustrates an example of the multidimensional process of evaluating and comparing predictive models for embodiments of the invention. Once the modeling techniques are run, the model evaluation framework for embodiments of the invention may be run for each modeling technique. Referring to FIG. 2, at 202, the predictions and data for each of several different predictive models may be received and, at 204, a score for each predictive model may be calculated for each of the dimensions of accuracy 206, value 208, utility 210, and actionability 212.

Thereafter, based on the respective scores for the dimensions of accuracy 206, value 208, utility 210, and actionability 212 for each predictive model, at 214, a composite score may be calculated for each predictive model. At 216, the composite scores for the various predictive models may be compared and, at 218, a recommendation may be generated that identifies the predictive model that is most suitable for the particular project. As previously noted, any number of different predictive models may be run and thereafter each model may be similarly evaluated with respect to the four dimensions of accuracy, value, utility, and actionability.

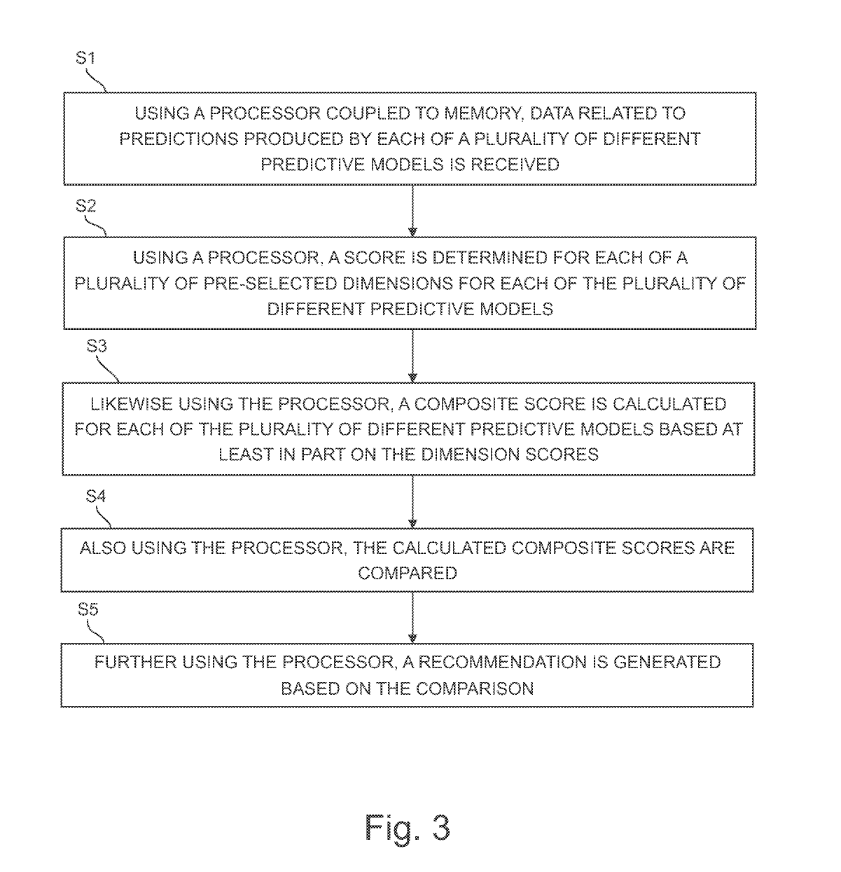

FIG. 3 is a flow chart which illustrates another example of the multidimensional process of evaluating and comparing predictive models for embodiments of the invention. Referring to FIG. 3, at S1, using a processor coupled to memory, data related to predictions produced by each of a plurality of different predictive models is received. At S2, using the processor, a score is determined for each of a plurality of pre-selected dimensions for each of the plurality of different predictive models. At S3, likewise using the processor, a composite score is calculated for each of the plurality of different predictive models based at least in part on the dimension scores. Also using the processor, at S4, the calculated composite scores are compared and, at S5, a recommendation is generated based on the comparison.

Embodiments of the invention may employ algorithms and analytic tools, such as various statistical analysis tools. Such statistical analysis tools may include, for example, SAS and SAS JMP software, big data platforms, MATHLAB, MINITAB, or any of numerous other commercially available analytical tools. The evaluation framework for embodiments of the invention may include one or more computer programs to evaluate predictive models. Such programs may apply, for example, various statistical models, such as disengagement analysis, to a problem. Thereafter, the programs may calculate the dimensional scores for accuracy, value, utility, and actionability, as well as a composite score for each predictive model. Some or all of such calculations may be performed either simultaneously or serially.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a Wide Area Network (WAN), a Local Area Network (LAN), a cellular network, or any other suitable network. Embodiments of the invention may employ client devices that may each comprise a computer-readable medium, including but not limited to, Random Access Memory (RAM) coupled to a processor. The processor may execute computer-executable program instructions stored in memory. Such processors may include, but are not limited to, a microprocessor, an Application Specific Integrated Circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a RAM. Such server devices, which may be a single computer system, may also be implemented as a network of computer processors. Examples of such server devices are servers, mainframe computers, networked computers, a processor-based device, and similar types of systems and devices.

1. A method of evaluating predictive models, comprising:
receiving, using a processor coupled to memory, data related to predictions produced by each of a plurality of different predictive models;
determining, using the processor, a score for each of a plurality of pre-selected dimensions for each of the plurality of different predictive models, said plurality of pre-selected dimensions consisting at least in part of a value dimension in terms of an amount of revenue lost as a result of disengaging customers reducing or discontinuing use of a credit card;
calculating, using the processor, a composite score for each of the plurality of different predictive models based at least in part on said dimension scores;
comparing, using the processor, the calculated composite scores; and
generating, using the processor, a recommendation based on said comparison.

2. The method of claim 1, wherein receiving the data further comprises receiving data related to predictions of behavior patterns of consumers produced by each of the plurality of different predictive models.

3. The method of claim 2, wherein receiving the data related to predictions of behavior patterns of consumers further comprises receiving data related to predictions of disengaging behavior patterns of consumers reducing or discontinuing use of a credit card produced by each of the plurality of different predictive models.

4. The method of claim 1, wherein determining the score for each of the plurality of pre-selected dimensions further comprises defining parameters of each of the plurality of pre-selected dimensions for each of the plurality of different predictive models.

5. The method of claim 1, wherein determining the score for each of the plurality of pre-selected dimensions further comprises determining a score for said value dimension, an accuracy dimension and a score for at least one other of the plurality of pre-selected dimensions for each of the plurality of different predictive models.

6. The method of claim 5, wherein determining the score for the accuracy dimension further comprises quantifying a predictive accuracy and reliability of the predictions produced by each of the plurality of different predictive models.

7. The method of claim 5, wherein determining the score for the at least one other of the pre-selected dimensions further comprises determining the score for at least one of said value dimension, a utility dimension, and an actionability dimension for each of the plurality of different predictive models.

8. The method of claim 5, wherein determining the score for at least one other of the pre-selected dimensions further comprises determining the score for each of said value dimension, a utility dimension, and an actionability dimension for each of the plurality of different predictive models.

9. The method of claim 8, wherein determining the score for the value dimension further comprises quantifying a cost savings associated with acting on predictions produced by each of the plurality of different predictive models.

10. The method of claim 8, wherein determining the score for the utility dimension further comprises quantifying a usability of predictions produced by each of the plurality of different predictive models.

11. The method of claim 8, wherein determining the score for the actionablity dimension further comprises quantifying an ability to take action on predictions produced by each of the plurality of different predictive models.

12. The method of claim 1, wherein determining the score for each of the plurality of pre-selected dimensions further comprises determining a numerical percentage score for each of the plurality of pre-selected dimensions for each of the plurality of different predictive models.

13. The method of claim 1, wherein calculating the composite score further comprises deriving a Z-score for each of the plurality of pre-selected dimensions for each of the plurality of different predictive models.

14. The method of claim 13, wherein calculating the composite score further comprises summing the Z-scores derived for the plurality of pre-selected dimensions for each of the plurality of different predictive models.

15. The method of claim 1, wherein comparing the calculated composite scores further comprises identifying one of the plurality of different predictive models as suitable for a particular project.

16. The method of claim 1, wherein generating the recommendation further comprises recommending one of the plurality of different predictive models as suitable for a particular project.

17. A system for evaluating prediction models, comprising:
a processor coupled to memory, the processor being programmed for:
receiving data related to predictions produced by each of a plurality of different predictive models;
determining a score for each of a plurality of pre-selected dimensions for each of the plurality of different predictive models, said plurality of pre-selected dimensions consisting at least in part of a value dimension in terms of an amount of revenue lost as a result of disengaging customers reducing or discontinuing use of a credit card product;
calculating a composite score for each of the plurality of different predictive models based at least in part on said dimension scores;
comparing the calculated composite scores; and
generating a recommendation based on said comparison.
